(19) United States
(12) Patent Application Publication
(10) Pub. No.: US 2022/0117335 A1
(43) Pub. Date: Apr. 21, 2022

(54) ANIMATED FACEMASK

(71) Applicant: Tyler Glaiel, Santa Cruz, CA (US)

(72) Inventor: Tyler Glaiel, Santa Cruz, CA (US)

(21) Appl. No.: 17/477,169

(22) Filed: Sep. 16, 2021

Related U.S. Application Data
(60) Provisional application No. 63/080,453, filed on Sep. 18, 2020.

(51) Int. Cl. A41D 27/08; A41D 13/11

(52) U.S. Cl. CPC A41D 27/085; A41D 13/1161

(57) ABSTRACT

An animated facemask apparatus is provided. The apparatus includes a face shield, an adjustable headband, and a controller. The face shield is adapted to be worn over the nose and mouth of a user and includes an LED array comprising a plurality of LED elements illuminated to display various shapes, objects, and figures about the user's mouth. The adjustable headband is coupled to opposing ends of the face shield and is configured to wrap around the back of the user's head to secure the face shield over the user's face. The controller is coupled to the headband and includes a central processing unit this is in electric communication with the LED array to transmit commands to the LED array.

### CROSS-REFERENCE TO RELATED APPLICATION

The present application claims priority under 35 USC § 119(e) to U.S. Provisional Patent Application No. 63/080,453, filed on Sep. 18, 2020, titled ANIMATED FACE SHIELD, the disclosure of which is hereby incorporated by reference in its entirety for all purposes.

### TECHNICAL FIELD

The present disclosure generally relates to a face covering, and more specifically, to an animated facemask.

### BACKGROUND

People commonly use facemasks worn over their mouth and nose to prevent the individual from inhaling and/or exhaling microscopic particles, including infectious and non-infectious contaminants. Facemasks are worn for many hours in some instances. In recent years, there has also been an increased awareness and concern for preventing contamination and infection of the public and health care personnel by airborne pathogens. Therefore, it has become necessary to prevent the spread of infections from person to person, from patient to health care worker and vice versa by preventing inhalation or exhalation of airborne infectious aerosols and/or particulate matter. In particular, with the outbreak of the recent SARS-CoV-2 (COVID-19) virus, the spread of such airborne pathogens and has become even a greater concern on the minds of public health officials because its potential impact.

Given recent government mandates requiring face coverings to be worn at most public facilities and in most public gatherings, efforts have been made to make face coverings more aesthetically pleasing. For example, face coverings are being made with various designs and colors to coordinate with a wearer's clothing, or various ornaments are being added to face coverings to add to their appeal. And for younger wearer's, various logo, cartoon characters, and designs may be embossed across the front of the face coverings to make the face coverings more fun and appealing to wear.

Given the extended amount of time that persons are now required to wear face covering, a need still exists for face coverings that provide some sort of enhanced aesthetics and appeal.

### SUMMARY OF THE INVENTION

An animated facemask apparatus is described herein. The apparatus generally comprises a faceshield, an adjustable headband, and a controller. The faceshield is adapted to be worn over the nose and mouth of a user and includes an LED array comprising a plurality of LED elements illuminated to display various shapes, objects, and figures about the user's mouth. The adjustable headband is coupled to opposing ends of the face shield and is configured to wrap around the back of the user's head to secure the face shield over the user's face. The controller is coupled to the headband and includes a central processing unit this is in electric communication with the LED array to transmit commands to the LED array. The apparatus further includes a mobile device having a processor for storing and executing a mobile application and a transmitter. The mobile device is in electric communication with the controller to transmit commands to the controller.

The disclosure herein is a summary of the invention and not an extensive overview of all contemplated embodiments. It should be appreciated that many other features, applications, embodiments, implementations and/or variations of the disclosed technology will be apparent to one with skill in the art upon examination of the accompanying figures and the following detailed description. While multiple implementations are disclosed, the drawings and detailed description are to be regarded as illustrative in nature and not restrictive. It is intended that all such additional systems, methods, features, and advantages be included within this description, and be protected by the accompanying claims.

### BRIEF DESCRIPTION OF THE DRAWINGS

This disclosure may be better understood by referring to the following figures. The components in the figures are not necessarily to scale, emphasis instead being placed upon illustrating the principles of the disclosure. In the figures, like reference numerals designate corresponding parts throughout the different views.

FIG. 1 is a front perspective view illustrating one example of a facemask apparatus according to the teachings of the present disclosure.

FIG. 2 is a front view of the facemask apparatus of FIG. 1.

FIG. 3 is a side perspective view of the facemask apparatus of FIG. 1.

FIG. 4 is a rear view of the facemask apparatus of FIG. 1.

FIG. 5 is another side perspective view of the facemask apparatus of FIG. 1.

FIG. 6 is a close-up rear perspective view of the headband of the facemask apparatus of FIG. 1.

FIG. 7 is another close-up rear perspective view of the headband of the facemask apparatus of FIG. 1.

FIG. 8 is an additional close-up rear perspective view of the headband of the facemask apparatus of FIG. 1.

FIG. 9A is a front view of the facemask apparatus of FIG. 1 worn by a user.

FIG. 9B is a front view of the facemask apparatus of FIG. 1 worn by a user.

FIG. 9C is another front view of the facemask apparatus of FIG. 1 worn by a user.

FIG. 9D is another front view of the facemask apparatus of FIG. 1 worn by a user.

### DETAILED DESCRIPTION

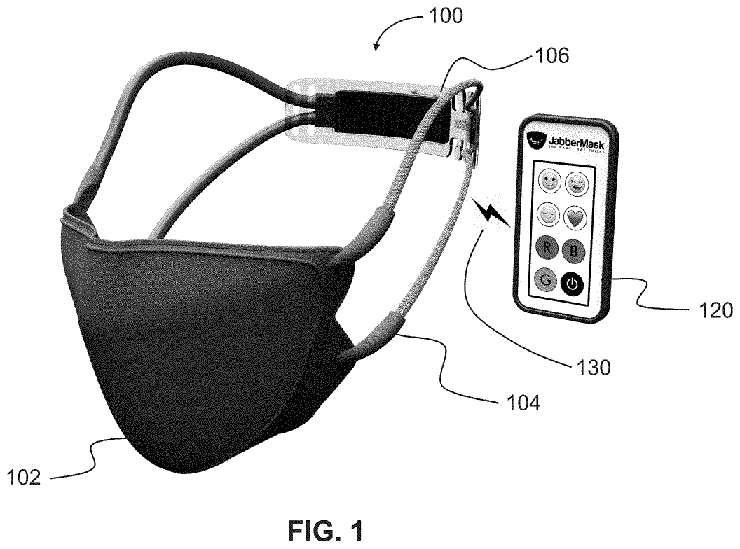

FIGS. 1-9D illustrate examples of various implementations of a facemask apparatus. As described herein, the apparatus may include a face shield carrying an array of light-emitting diodes (LEDs), an adjustable headband, and a controller in electrical connection with the face shield. In use, the LEDs are engaged and illuminated to display various designs about the face of the user.

FIG. 1 is a front perspective view of one example of a facemask apparatus 100 according to the teachings of the present disclosure. As shown, the apparatus 100 includes a face shield 102 adapted to be worn over the face of a user, an adjustable headband 104 coupled to opposing ends of the face shield 102, and a controller 106 coupled to a portion of the adjustable headband 104.

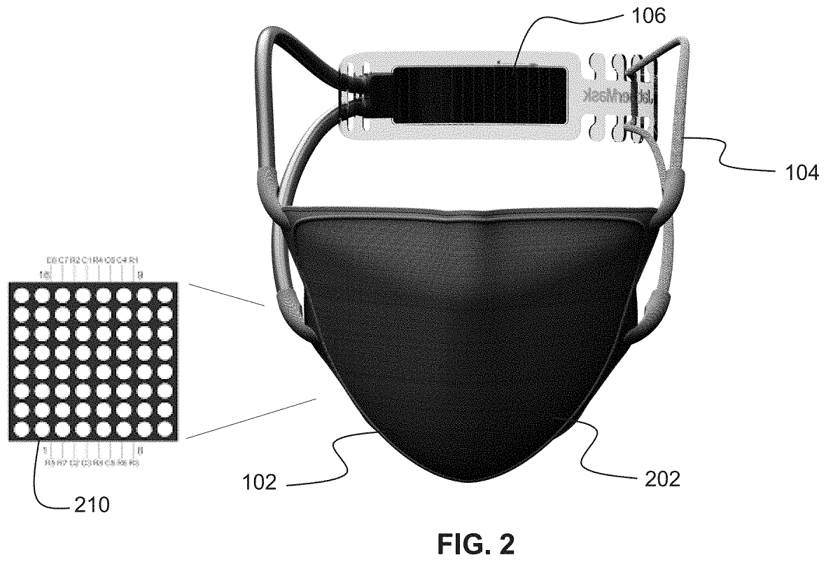

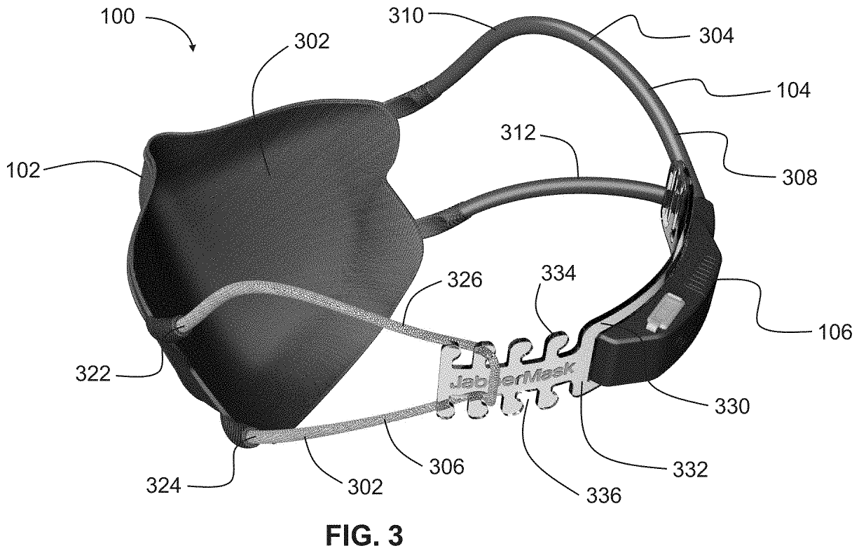

FIG. 2 is a front view of the facemask apparatus 100. As shown, the face shield 102 may comprise a substantially v-shaped design adapted to sufficiently cover the nose and mouth areas of the user's face. The face shield 102 includes an inner layer of material 302 (FIG. 3) and an outer cloth overlay 202. The face shield 102 may be made of cotton or any other suitable cloth or machine washable material.

The inner layer 302 (FIG. 3) and the outer cloth overlay 202 are integrally formed to define a pocket (not shown) between them. The pocket is adapted to house an LED array 210. In some implementations, the LED array 210 may comprise a 6-inch by 6-inch square LED light circuit board assembly. In these implementations, the circuit board assembly may comprise 36 equally spaced RGB LED elements. In other implementations, the LED array 210 may comprise an 8-inch by 8-inch square LED light circuit board assembly. In these implementations, the circuit board assembly may comprise 64 equally spaced RGB LED elements.

The LED array 210 may be electrically coupled to the controller 106 by electrical wiring fed through the headband 104. In use, the LED elements are illuminated to display various shapes, objects, and figures across the user's mouth, as discussed in further detail below.

FIG. 3 is a rear perspective view of the facemask apparatus 100. As shown, the headband 104 includes a fixed portion 304 coupled to one end of the face shield 102 and an adjustable portion 306 coupled to an opposite end of the face shield 102. The fixed portion 304 and the adjustable portion 306 define a loop 308 whose dimensions may be adjusted to complement and provide a desired fit about the user's head.

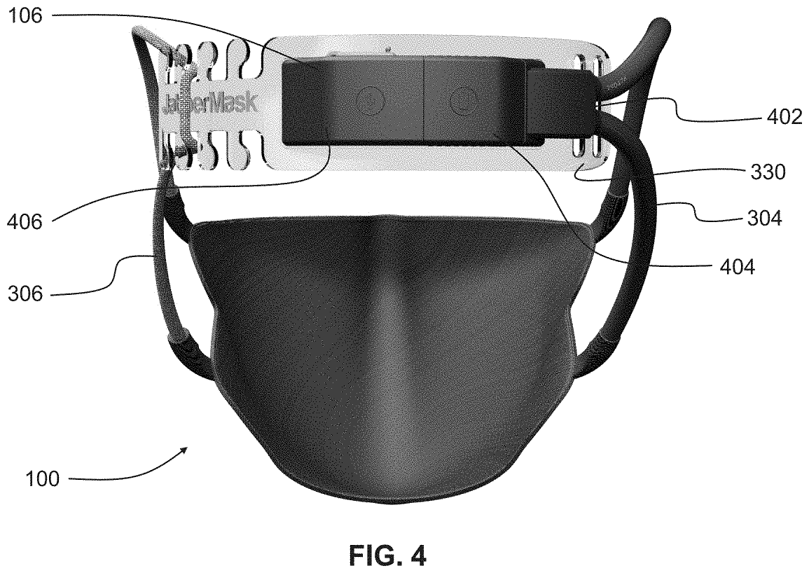

The fixed portion 304 may include a pair of tubular members 310 and 312. The tubular members 310 and 312 may be made of plastic or any other suitable material. The tubular members 310 and 312 may be hollowed for passing electrical wiring therethrough. Each tubular member has a first end coupled to an end of the face shield 102 and a second end attached to an electrical connector 402 (see FIG. 4) coupled to the controller 106. The fixed portion 304 may be adapted such that tubular member 310 may be secured about the user's head above the user's ear, and tubular member 312 may be secured about the user's head below the user's ear.

The adjustable portion 306 may comprise a resilient member 302 having a first end 322 coupled to an upper end of the face shield 102 and a second end 324 coupled to a lower end of the face shield 102. In this way, the resilient member 302 is coupled to the face shield 102 to define a loop 326. The resilient member 302 may comprise an elastic band or other stretchable material.

As further shown, the facemask apparatus 100 may include a rear headrest 330 adapted to rest about the back of the user's head. The headrest 330 may be made of plastic or any other suitable material. The headrest 330 may comprise a slender elongated member 332 having a first end, and an opposing second end having a series of hooks 334 defining a plurality of notches 336. The notches 336 are configured to receive the loop 326 of the adjustable portion 306 of the headband 104 along desired locations of the second end of the headrest 330 to adjust the dimensions of loop 308 to secure the headband 104 about the user's head.

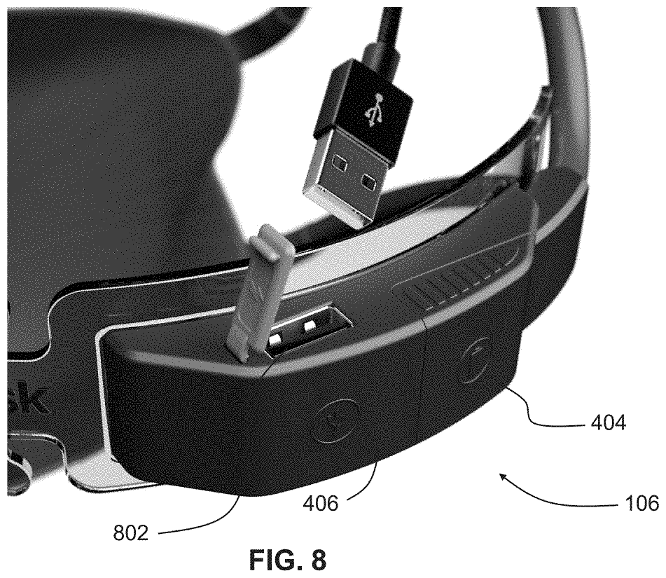

FIG. 4 is a rear view of the facemask apparatus 100. As shown, the controller 106 may be coupled to the headrest 330 by any suitable mechanical means. The controller 106 may include a housing having a battery portion 404 and a cpu portion 406. The battery portion 404 is configured to house a battery source. The battery source may include a AAAA or AAA battery or a rechargeable battery. The cpu portion 406 is configured to house a central processing unit or other circuitry. The cpu portion 406 may also include a USB port 802 (FIG. 8) for connecting a USB or micro-USB cable to the cpu portion 406 for purposes of, for example, recharging a rechargeable battery source.

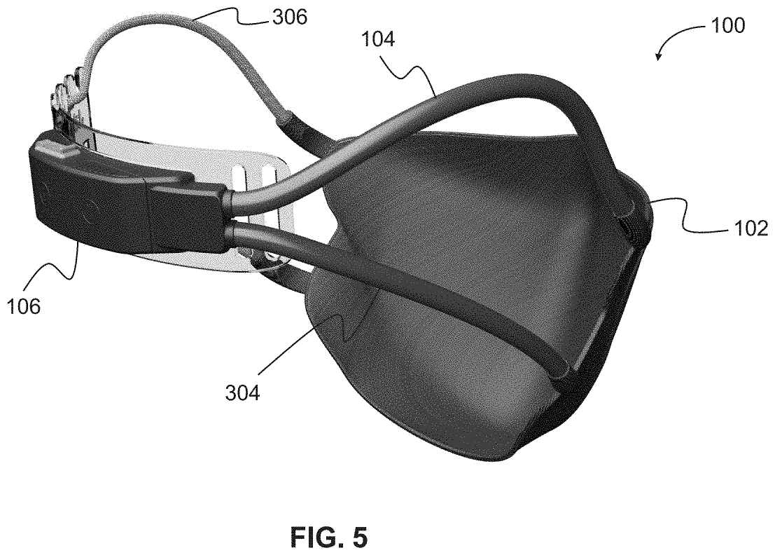

FIG. 5 is a rear perspective view of the facemask apparatus 100.

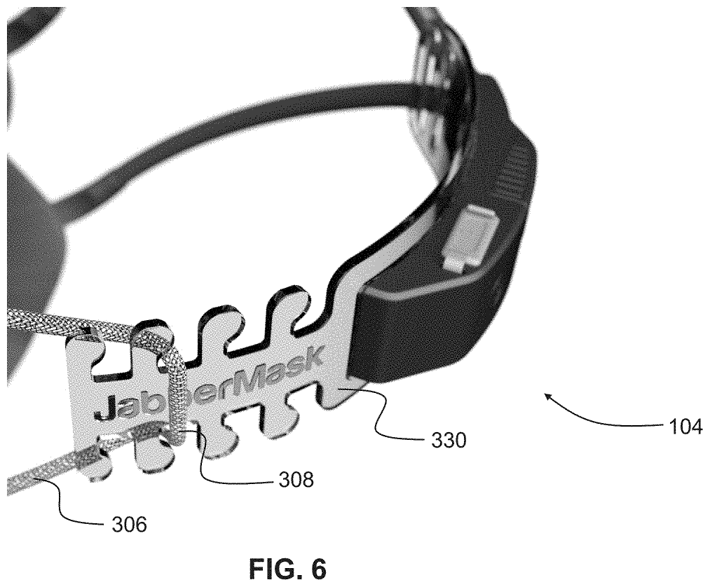

FIG. 6 is a close-up rear perspective view of the headband 104. This figure shows more clearly how loop 308 of the adjustable portion 306 is coupled with and received by the notches 336 on the second end of the headrest 330.

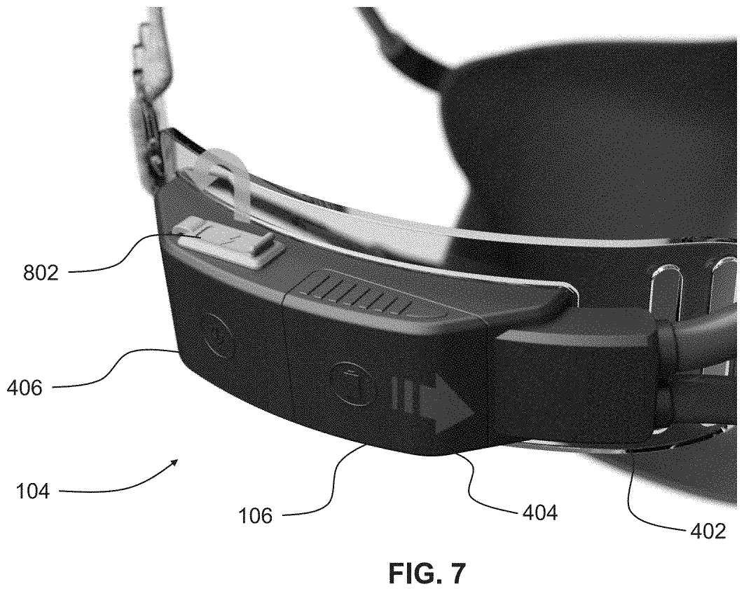

FIG. 7 is a close-up rear perspective view of the headband 104 showing how the fixed portion 304 of the headband 104 is coupled to the controller 106.

FIG. 8 is a close-up rear perspective view of the headband 104 showing the usb port 802 in the cpu portion 406 of the controller 106.

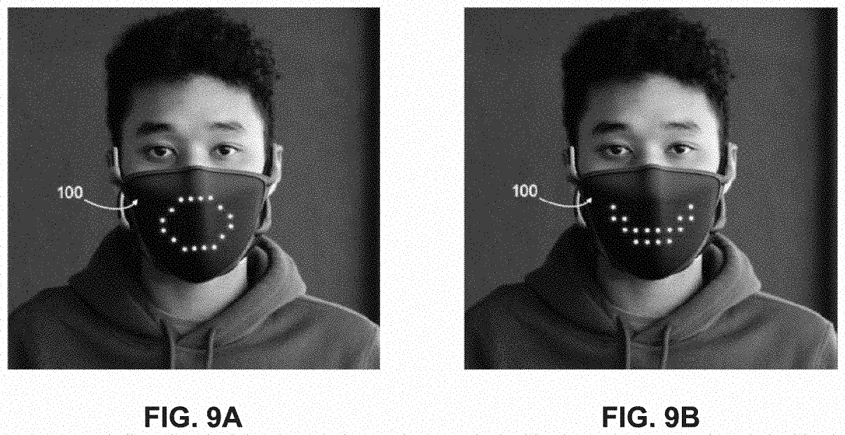

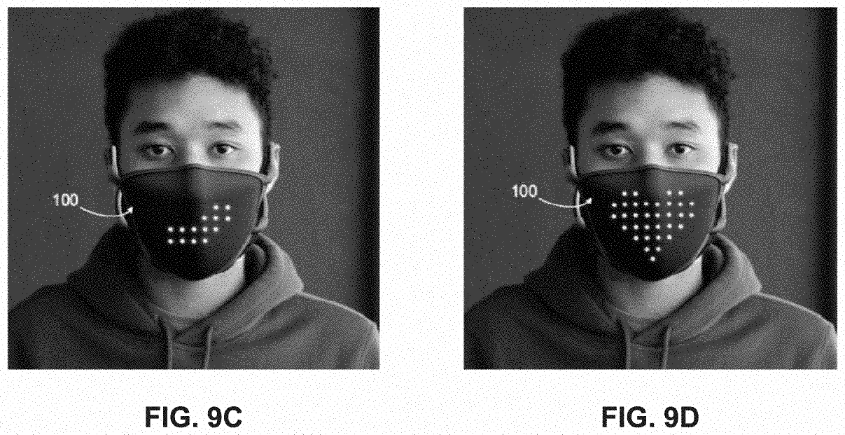

FIG. 9A is a front view of the facemask apparatus 100 worn by a user. As shown, the LEDs of the LED array may be powered to display various images, shapes, and lettering across the front of the face shield 102. In this figure, the displayed image is a digitally simulated mouth. In some implementations, the apparatus 100 may include a transducer, such as a microphone (not shown), disposed in the pocket of the shield 102 proximal the mouth of the user. The transducer is electrically coupled to the controller 106. The transducer is configured to convert the sounds waves of the user into an electrical signal, such that a stronger signal is generated as the user speaks louder (i.e., the amplitude of the user's voice increases). In this way, the LEDs will digitally simulate a mouth opening and closing as the user speaks. In particular, the transducer records what the user is saying and coverts the audible sounds waves into electrical signals that illuminate the LED elements to animate the digitally simulated mouth and trigger the display of emoji images when certain sounds are made.

FIG. 9B is a front view of the facemask apparatus 100 worn by a user. In this figure, the LEDs of the LED array digitally simulate a smile.

FIG. 9C is a front view of the facemask apparatus 100 worn by a user. In this figure, the LEDs of the LED array digitally simulate a slanted smile.

FIG. 9D is a front view of the facemask apparatus 100 worn by a user. In this figure, the LEDs of the LED array digitally display a heart emoji.

Referring back to FIG. 1, some implementations, the facemask apparatus 100 may be electrically coupled to a mobile device 120 via a wireless network connection 130. The wireless network connection 130 may be a computer network (e.g., the Internet) or Wi-Fi.

The mobile device 120 may be a handheld or other portable device, such as a mobile phone, smartphone, PDA, iPad, or tablet. The mobile device 120 may include software, namely, a mobile application for transmitting commands to the controller 106. Using the mobile application, the user may command the LED array to display certain images, for example emojis, or display certain images, for example the digitally simulated mouth, in a desired color or series of colors.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. A facemask apparatus, the apparatus comprising:
a face shield adapted to be worn over the nose and mouth of a user, the face shield including and LED array comprising a plurality of LED elements illuminated to display various shapes, objects, and figures about the user's mouth;
an adjustable headband coupled to opposing ends of the face shield, the headband being configured to wrap around the back of the user's head to secure the face shield over the user's face;
a controller coupled to the headband, the controller having a central processing unit in electric communication with the LED array to transmit commands to the LED array; and
a mobile device having a processor for storing and executing a mobile application and a transmitter, the mobile device being an electric communication with the controller to transmit commands to the controller.
